(19) United States
(12) Patent Application Publication
(10) Pub. No.: US 2009/0162680 A1
(43) Pub. Date: Jun. 25, 2009

(54) PROCESS FOR MAKING WOOD LAMINATES USING FAST SETTING ADHESIVES AT AMBIENT TEMPERATURE

(76) Inventors: Jun Zheng, Eugene, OR (US); Earl Payton, Lincolnton, NC (US); Christopher Reed, Fernley, NV (US); Gregory F. Nieckarz, Eugene, OR (US)

Correspondence Address: HEXION SPECIALTY CHEMICALS, INC., 12650 Directors Drive, Suite 100, Stafford, TX, 77477, US

(21) Appl. No.: 12/335,238

(22) Filed: Dec. 15, 2008

Related U.S. Application Data
(63) Continuation-in-part of application No. 11/269,276, filed on Nov. 8, 2005, now abandoned.

(51) Int. Cl. B32B 15/082; B29C 65/48; B32B 9/04; B32B 27/10

(52) U.S. Cl. 428/461; 156/182; 428/500; 428/511

(57) ABSTRACT

A process to form a multilayer article comprising pressing a stack comprising two or more panels, wherein each panel comprises a surface layer and a substrate layer, wherein a side of the surface layer is contacted to a side of the substrate layer, and wherein the contacting sides of the surface layer and substrate layer have a fast-setting adhesive disposed there between; and wherein pressing comprises applying uniform pressure to the stack orthogonal to the plane of the panels, at ambient temperature and for a time of 0.1 to 20 minutes, and with no subsequent hot pressing. Articles prepared using the method are also disclosed.

### CROSS REFERENCE TO RELATED APPLICATIONS

This application is a continuation in part of U.S. patent application Ser. No. 11/269,276 which was filed on Nov. 8, 2005 and which is fully incorporated herein by reference in its entirety.

### FIELD OF THE INVENTION

This invention relates to a process to form wood laminates prepared using fast setting adhesives, at ambient temperature.

### BACKGROUND OF THE INVENTION

Formaldehyde-containing resins such as urea-formaldehyde resins, melamine-urea-formaldehyde resins, and more recently phenol-formaldehyde resins have long been used for preparing wood composites for interior and decorative use, particularly in finish grade and decorative plywoods, decorative veneers, and composite wood flooring. Such resins generally have disadvantages for these uses, arising from the need to use elevated processing temperatures under pressure (i.e., hot pressing) to effect a complete cure of the adhesive. Disadvantages of elevated cure temperatures may include higher incidences of surface defects, such as staining associated with high temperature processing in the presence of both the metal presses and moisture, that can adversely affect yield and increase cost. A common surface defect is referred to in the art as “bleed through”, which is caused by glue transfer from the bondline to the veneer surface. In addition, hot pressing may result in added process costs including increased cycle time with lower throughput (which is limited by the number of panels that can be produced in each press cycle) and required heating and cooling periods, higher power consumption for heating, increased labor costs wherein multiple operators are required to operate the hot presses, and panel warpage. While improvements have been made with respect to decreasing the processing temperature for such formaldehyde-containing resins, elevated temperatures and the associated yield, process cost, and cycle time issues are still present.

Another drawback of using urea-formaldehyde type resins as binders for wood products is that such resins can release formaldehyde which can either come from the residual formaldehyde in the resin or due to the hydrolysis of the cured resin. This can be an undesirable for interior applications. While the amount of the formaldehyde being liberated may be small, detectable amounts may be emitted. As a result, there has been an effort to reduce or eliminate formaldehyde emissions, according to criteria in the LEED standards (Leadership in Energy and Environmental Design) as put forth by the USGBC (U.S Green Building Council).

Ambient temperature curing processes using emulsion polymer isocyanate (EPI) or other latex type adhesives (e.g. polyvinyl acetate (PVAc) and ethylene vinyl acetate (EVAc or VAE) are desirable, as above-mentioned adhesives do not contain urea-formaldehyde components, per requirements in current LEED Standards. However, such ambient temperature curing adhesives may be more expensive than conventional formaldehyde-based adhesive binders and may set and cure too slowly to be economical for a volume manufacturing process. Compromised board properties such as decreased internal bond strengths can also be encountered which can lead to delamination, i.e. the separation between the bonded wood veneers.

What is needed therefore is a method of forming wood laminates using short press times at ambient temperature using formaldehyde-free adhesives.

A suitable method desirably uses adhesives that can provide a bonded product at ambient temperature, which has board properties that are comparable to or better than similar bonded products produced using a hot press, and which has minimal or no formaldehyde emissions.

### SUMMARY

The above deficiencies are met by, in an embodiment, a process to form a multilayer article (e.g., multi-ply decorative hardwood plywoods with surface and core layers) comprising pressing a stack comprising two or more panels, wherein each panel comprises a surface layer and a substrate layer, wherein a side of the surface layer is contacted to a side of the substrate layer, and wherein the contacting sides of the surface layer and substrate layer have a fast-setting adhesive disposed there between; and wherein pressing comprises applying uniform pressure to the stack orthogonal to the plane of the panels, at ambient temperature and for a time of at least about 0.1 minutes, and with no subsequent hot pressing. Articles prepared using the method are also disclosed.

In another embodiment, a process to form a multilayer article comprising a surface layer and a substrate layer (e.g., two or more ply decorative hardwood plywoods with surface and core layers), comprises coating a side of the substrate layer with a fast curing adhesive, forming a panel by contacting a side of the surface layer to the side of the substrate layer having the fast curing adhesive disposed thereon, stacking at least two panels, and applying uniform pressure to the stack orthogonal to the plane of the panels, at ambient temperature and for a time of at least about 0.1 minutes, and with no subsequent hot pressing.

In another embodiment, a process to form a multilayer article (e.g., line-by-line multi-ply decorative hardwood plywood having surface, multiple core, and backing layers), comprising a surface layer; a substrate layer comprising at least two core layers, wherein each core layer has a first side and a second side opposite the first side, and wherein the substrate layer has a first side and a second side opposite the first side; and a backing layer; comprises coating the core layers with fast setting adhesive so that the fast setting adhesive is disposed on each of the first side and second sides of each core layer, forming a panel by contacting the coated sides of the core layers to form the substrate layer, contacting a surface layer to the first side of the substrate layer, and contacting a backing layer to the second side of the substrate layer opposite the first layer, stacking at least two panels, and applying uniform pressure to the stacked panels in a direction orthogonal to the plane of the layers in the stack, at ambient temperature and for a time of at least about 0.1 minutes, and with no subsequent hot pressing.

In another embodiment, a multilayer article prepared by the above process passes the 3-cycle soak test according to ANSI/HPVA HP-1-1994, after aging for at least one day.

In still another embodiment, a process to form a multilayer article comprising pressing a stack comprising two or more panels; wherein each panel comprises a surface layer and a substrate layer, wherein a side of the surface layer is contacted to a side of the substrate layer, and wherein the contacting sides of the surface layer and substrate layer have a fast-setting adhesive comprising (i) a compounded emulsion polymer selected from the group consisting of a styrene-butadiene rubber latex, a modified styrene-butadiene rubber latex, polyvinyl acetate, ethylene vinyl acetate, and combinations thereof and (ii) pMDI as a crosslinking compound disposed there between; and wherein pressing comprises applying uniform pressure to the stack orthogonal to the plane of the panels, at ambient temperature and for a time of at least 0.1 minutes, and with no subsequent hot pressing.

In yet another embodiment, A process to form a multilayer article comprising pressing a stack comprising two or more panels; wherein each panel comprises a surface layer and a substrate layer, wherein a side of the surface layer is contacted to a side of the substrate layer, and wherein the contacting sides of the surface layer and substrate layer have a fast-setting adhesive comprising (i) a compounded ethylene vinyl acetate emulsion polymer and (ii) a crosslinking compound disposed there between; and wherein pressing comprises applying uniform pressure to the stack orthogonal to the plane of the panels, at ambient temperature and for a time of at least 0.1 minutes, and with no subsequent hot pressing.

The invention is further described by the following figures.

### BRIEF DESCRIPTION OF THE FIGURES

FIG. 1 shows an embodiment of a multilayer article.

FIG. 2 shows another embodiment of a multilayer article.

FIG. 3 shows another embodiment of a multilayer article.

### DETAILED DESCRIPTION

It has been found that multilayer articles (e.g., plywood, flooring panels, and the like), may be efficiently prepared by a process comprising assembling (also referred to as “laying up”) lignocellulosic and/or suitable non-lignocellulosic layers with a fast setting adhesive disposed between the layers to form a multilayer assembly (e.g., a panel), stacking two or more multilayer assemblies to form a stack, and applying uniform pressure to the stack. Pressure is applied orthogonal to the plane of the multilayer assemblies and is done at ambient temperature and using short press times. The fast curing adhesive provides a rapid bonding of the layers in the panel at ambient temperatures of about 45 to about 120° F. (about 7 to about 49° C.) using press times of at least 0.1 minutes, preferably at least 1 minute, more preferably in the range of about 3 minutes to about 60 minutes, even more preferably about 3 minutes to about 45 minutes, even more preferably about 3 minutes to about 30 minutes and most preferably about 5 minutes to about 20 minutes. Multilayer articles prepared using this process form a bond between the layers of the article without need for hot pressing. The process may be used to adhere together lignocellulosic layers such as decorative wood veneers with, for example, particle board, veneer core, medium density fiberboard (MDF), plywood, or oriented strand board (OSB), to prepare multilayer articles including, for example, panels such as flooring panels and decorative hardwood plywoods. Multilayer articles prepared according to the above method, such as panels, have excellent board properties including improved flatness, zero formaldehyde emissions from the fast curing adhesive, excellent bond strength, and excellent resistance to delamination as evidenced by at least passing the 3-cycle soak test according to ANSI/HPVA HP-1-1994.

As used herein, “cure”, “curing,” “cured,” and similar terms are intended to embrace the structural and/or morphological change which occurs in the fast curing adhesive of the present invention as it forms bonds by mechanical interlocking, covalent chemical reaction, and secondary adhesive interactions such as ionic interaction (e.g., “clustering”), and hydrogen bonding. At least one of these processes may provide the improved adhesion between lignocellulosic layers in the article.

Multilayer articles prepared using the method disclosed herein are generally prepared by contacting a first lignocellulosic layer to a second lignocellulosic layer using a fast curing adhesive. Suitable fast-curing adhesives include, but are not limited to, water-based adhesives with an emulsion polymer latex component (also referred to as emulsion polymer adhesives. Emulsion polymer adhesives can be a two-part adhesive comprising a first part comprising a compounded emulsion polymer, and a second part comprising a suitable crosslinking compound such as an isocyanate compound, aziridine compound, epoxy compound, or a combination comprising at least one of these. A specifically useful type of emulsion polymer adhesive is an emulsion polymer-isocyanate (EPI) adhesive, wherein the crosslinking compound is an isocyanate compound.

The emulsion polymer adhesive comprises a compounded emulsion polymer, comprising at least one emulsion polymer and additives. Emulsion polymers are formed by polymerization of suitable monomers in aqueous solution using diluent solvents and emulsifiers, to create small organic phases of the monomers and diluents dispersed in the aqueous phase. Upon completion of the polymerization, the emulsion polymer is provided as an aqueous solution in the original reaction solution (i.e., as a latex emulsion). Properties of the emulsion polymer, such as glass transition temperature (Tg), are believed to have an effect on the bonding performance. Emulsion polymers having a Tg between negative 30° C. and 30° C. may have a tack suitable for use herein.

Polymerization to provide the emulsion polymer may be carried out using a variety of radically polymerizable monomers, both functionalized with substituent groups, and unfunctionalized. Examples of suitable monomers may include butadiene, isoprene, 1,3-heptadiene, methyl-1,3-pentadiene, 2,3-dimethyl-1,3-butadiene, 2-ethyl-1,3-pentadiene; 1,3- and 2,4-hexadienes, vinyl formate, vinyl acetate, vinyl propionate, vinyl butyrate, vinyl pivalate, vinyl isobutyrate, vinyl pentanoate, vinyl hexanoate, vinyl cyclohexanoate, styrene, 3-methylstyrene, 3,5-diethylstyrene, 4-n-propylstyrene, alpha-methylstyrene, alpha-methyl vinyltoluene, alpha-chlorostyrene, alpha-bromostyrene, dichlorostyrene, dibromostyrene, tetra-chlorostyrene, and the like, and combinations comprising at least one of the foregoing compounds. Other monomers that may be copolymerized with conjugated dienes, where used, include monovinylic monomers such as itaconic acid, acrylamide, N-substituted acrylamide or methacrylamide, maleic anhydride, maleimide, N-alkyl-, aryl-, or haloaryl-substituted maleimide, glycidyl (meth)acrylates, acrylic acid, methyl (meth)acrylate, ethyl (meth)acrylate, n-butyl (meth)acrylate, t-butyl (meth)acrylate, n-propyl (meth)acrylate, isopropyl (meth)acrylate, 2-ethylhexyl (meth)acrylate, acrylonitrile, methacrylonitrile, and the like, and a combination comprising at least one of the foregoing. Polyfunctional crosslinking comonomer may also be present, such as, for example, divinylbenzene, alkylenediol di(meth)acrylates such as ethyleneglycol di(meth)acrylate, alkylenetriol tri(meth)acrylates such as trimethylolpropane tri(meth)acrylate, polyester di(meth)acrylates, bisacrylamides, triallyl cyanurate, triallyl isocyanurate, allyl (meth)acrylate, diallyl maleate, diallyl fumarate, diallyl adipate, triallyl esters of citric acid, and the like. Where two or more monomers are used, the polymerization may be carried out to provide copolymers including block copolymers, diblock copolymers, triblock copolymers, triblock terpolymers, multiblock copolymers, random copolymers, and the like, and a combination comprising at least one of these. Where a block copolymer is desired which comprises two different monomers, suitable monomers for a first block may include olefinic monomers such as, for example, ethylene, propylene, butadiene, isoprene, vinyl acetate, and the like, and a combination comprising at least one of these; and suitable monomers for a second block may include (meth)acrylamide, (meth)acrylic acid, methyl(meth)acrylate, 2-ethyl hexyl (meth)acrylate, 2-hydroxyethyl(meth)acrylate, 2-hydroxypropyl (meth)acrylate, styrene, alpha-methyl styrene, 4-methylstyrene, 4-chlorostyrene, and the like, and a combination comprising at least one of these.

Specifically suitable emulsion polymers are modified to have crosslinking capability with a crosslinking functional group. Crosslinking functional groups may be incorporated into the emulsion polymer by post-polymerization functionalization, or by copolymerization of a monomer having a suitable functional group. Heterodifunctional monomers having a reactive crosslinkable group depending therefrom may be included, wherein the crosslinkable groups may include hydroxyl, carboxylic acid, carboxylate, amino, thiol, methylol, and the like. Useful crosslinkable monomers for copolymerizing with a vinyl ester include, for example, N-hydroxymethyl (meth)acrylamide, (meth)acrylic acid, 2-hydroxyethyl acrylate, and vinyl acetate (hydrolysable in a post-polymerization step to generate the vinyl alcohol).

A specifically useful type of emulsion polymer includes commercially available styrene-butadiene rubber (SBR) latex, also referred to herein as “SBR” and “SBR polymer”. SBR may be obtained and used in modified form, unmodified form, or as a combination comprising at least of these. The term “modified” as used herein means a latex in which the functional group is covalently bonded to the SBR polymer. Modified SBR may be obtained by adding groups such, for example, an amide, amino, sulfonic acid, sulfonate, epoxy, hydroxyl, carboxylic acid, carboxylate, or carboxylic acid salt to SBR by copolymerizing with correspondingly functionalized unsaturated monomers, or by functionalizing the polymer post-polymerization. Typically, a modified SBR polymer may be functionalized with reactive groups by incorporating a suitably functionalized monomer. Specifically useful functional monomers included with the styrene and butadiene monomers include hydroxy-containing (meth)acrylates such as 2-hydroxyethyl (meth)acrylate, 2-hydroxypropyl (meth)acrylate, and hydroxymethyl (meth)acrylamide; amide monomers such as (meth)acrylamide and maleimide; carboxylic acid group-containing unsaturated monomers such as acrylic acid, methacrylic acid, fumaric acid, maleic acid, maleic anhydride, crotonic acid, itaconic acid, partially esterified itaconic acid, maleic acid, maleic anhydride, partially esterified maleic acid and the like. The unsaturated organic acid monomer may be present in the modified SBR in amounts of 0.1 to 20% by weight, specifically 0.2 to 10% by weight, based on the total solids.

Modified SBR polymers can be prepared as described above in an aqueous system according to methods known in the art, using a radical initiator, a surfactant and an adjusting agent. SBR in which a carboxylic acid salt (for instance, sodium, potassium, calcium and ammonium salts) is present may be formed by adding a basic substance to a carboxylic acid group-containing SBR. Alternatively, the SBR need not necessarily contain a carboxylic acid group or its salt, but a carboxylic acid group or its salt may be present in a surfactant or stabilizer used in the polymerization process. Suitable surfactants or stabilizers include saponified products of fatty acids.

Other examples of suitable emulsion polymer latexes include acrylic latexes, polyvinyl acetate (PVAc), ethylene vinyl acetate (EVAc), butadiene-acrylonitrile latex (NBR), styrene acrylics, and the like, or a combination comprising at least one of these. In an exemplary embodiment, a suitable EVAc emulsion is Airflex® 323 EVAc emulsion, from Air Products Inc., which is provided with an emulsion solids content of 55% by weight, and a Tg of 22° C., and a pH of about 5 to about 6. Emulsion polymers suitable for use herein are also disclosed in U.S. Pat. No. 3,931,088 the contents of which are disclosed herein by reference. Other aqueous-based polymer dispersions suitable for use in preparing an emulsion polymer compound include aqueous polyurethane dispersions. Suitable polyurethane dispersions may be prepared using elastomeric and/or high molecular weight alkyl polyurethanes, typically linear alkyl, cycloalkyl, or aryl polyester urethanes.

The compounded emulsion polymer also comprises a thickener. Suitable thickeners include hydroxyl containing polymers, which are included to provide increased crosslinking capability in the adhesive to improve bond strength, and heat and water resistance. Examples of thickeners include hydroxy containing polymers such as polyvinyl alcohol (PVA), hydroxyethyl cellulose (HEC), and the like. Of these, PVA is specifically useful as a thickener. A suitable PVA may have a degree of polymerization ranging from 300 to 2,500 and a degree of saponification of from 80 to 100 mole percent of the polymer, wherein it desirable that the PVA have a high degree of saponification. Thickeners may be present in the emulsion polymer adhesive in an amount of about 0.1 to about 30 parts by weight (pbw), specifically about 0.5 to about 20 pbw, more specifically about 1 to about 10 pbw, and still more specifically about 2 to about 8 pbw, per 100 parts by weight of the compounded emulsion polymer.

The compounded emulsion polymer may further comprise filler. The presence of filler in the adhesive may provide added stiffness and heat resistance to the cured emulsion polymer adhesive, and may reduce material cost. Suitable fillers may include either or both organic and inorganic filler. Examples of each of these include wood flour, starch, silica, calcium carbonate, clay, and the like. Filler may be used in the emulsion polymer adhesive in an amount of about 0.1 to about 50 pbw, specifically about 7 to about 40 pbw, more specifically about 9 to about 35 pbw, and still more specifically about 10 to about 30 pbw, per 100 parts by weight of compounded emulsion polymer.

Other components may be present in the compounded emulsion polymer in suitable amounts. Additives such as plasticizers, antioxidants, defoamer and antifoams, and wetting agents, dispersants, and surfactants may thus be included, wherein it is understood that the amounts and types of these additives may be selected such that the desired properties of the emulsion polymer adhesive and components therein, such as latex particle coalescence and adhesive wetting, and bulk properties such as bond strength, are not adversely affected.

The emulsion polymer adhesive further comprises a crosslinking compound. Where an EPI adhesive is desired, the EPI adhesive comprises an isocyanate compound. Aryl, alkyl, cycloalkyl, or mixtures comprising aryl, alkyl, and/or cycloalkyl isocyanate compounds may be used. The isocyanate compounds used to prepare the EPI adhesive can comprise di-, tri-, tetra-, or polyvalent arylene, alkylene, and arylalkylene groups that may be the same or different. The divalent units can be C₆-C₃₀ arylene, substituted C₆-C₃₀ arylene, C₁-C₃₀ alkylene, C₃-C₃₀ cycloalkylene groups, and substituted C₃-C₃₀ cycloalkylene groups, wherein substituents can include halogen, C₁-C₈ alkyl-, and C₁-C₈ alkoxy-groups.

The alkyl polyisocyanate component contains about 4 to 20 carbon atoms. Exemplary alkyl polyisocyanates include isophorone diisocyanate; dicyclohexylmethane-4,4′-diisocyanate, dicyclohexylmethane-2,4′-diisocyanate, dicyclohexylmethane-2,2′-diisocyanate, and mixtures of these; 1,4-tetramethylene diisocyanate; 1,5-pentamethylene diisocyanate; 1,6-hexamethylene diisocyanate; 1,7-heptamethylene diisocyanate; 1,8-octamethylene diisocyanate; 1,9-nonamethylene diisocyanate; 1,10-decamethylene diisocyanate; 2,2,4-trimethyl-1,5-pentamethylene diisocyanate; 2,2′-dimethyl-1,5-pentamethylene diisocyanate; 3-methoxy-1,6-hexamethylene diisocyanate; 3-butoxy-1,6-hexamethylene diisocyanate; omega, omega′-dipropylether diisocyanate; 1,4-cyclohexyl diisocyanate; 1,3-cyclohexyl diisocyanate; trimethylhexamethylene diisocyanate; and combinations comprising at least one of the foregoing. Suitable aryl diisocyanates include, for example, toluene diisocyanate (TDI), available commercially as Desmodur® T from Bayer Corp., hydrogenated TDI, trimethylolpropane (TMP)-TDI adduct (Desmodur® L), triphenylmethane-triisocyanate (TTI, Desmodur® R), methylene bis-phenylisocyanate (diphenylmethane diisocyanate, MDI, Desmodur® 44), methylene bis-cyclohexylisocyanate (hydrogenated MDI), hexamethylene diisocyanate (Desmodur® N), xylenediisocyanate, 4,4′-dicyclohexylmethane-diisocyanate, naphthalene diisocyanate, and the like.

Polymeric polyisocyanates may also be used in EPI adhesives as the crosslinker to provide better strength and durability properties. For example, a suitable polymeric polyisocyanate includes a mixture of diphenylmethane diisocyanate (MDI) monomers and higher polyisocyanate oligomers with an average functionality larger than two. The MDI content may typically be about 50 weight percent (wt %) with the rest being high order oligomers (e.g. triisocyanate at less than or equal to about 30 wt %, tetraisocyanate at less than or equal to about 10 wt %, and pentaisocyanate at less than or equal to about 10 wt %). The isomers of MDI in commercial polymeric MDI (pMDI) may comprise 4,4′-MDI at less than or equal to about 90 wt %, a small amount of 2,4′-MDI at about 1 to about 20 wt %, and a trace amount (less than about 1 wt %) of 2,2′-MDI. pMDI desirably has extremely low vapor pressure (less than about 1×10⁻³ mmHg at 20° C.) and high reactivity. However, the percentage of 4,4′-MDI in the pMDI can affect the reactivity, and thus affect the speed of cross-linking with the emulsion polymer latex component, and therefore may necessitate close control of the isomeric composition of the pMDI.

The isocyanate compound may include a solvent to inhibit hydrolysis and promote dispersion of the isocyanate compound when combined with the aqueous compounded emulsion polymer. Suitable solvents may typically include aliphatic hydrocarbons, aromatic hydrocarbons, or mixtures thereof, examples of which include toluene, xylene, benzene, gasoline, kerosene, ligroin, tetralin, decalin, terpentine oil, pine oil, liquid paraffin and alkylbenzene, and the like; halogenated hydrocarbons including, for example methylene chloride, chlorobenzene, chlorotoluene and bromobenzene, and the like; ketones, including methyl isobutyl ketone, methyl-n-amyl ketone, methyl-n-hexyl ketone, ethyl-n-butyl ketone, di-n-propyl ketone and acetophenone, and the like; ethers, including for example isopropyl ether, methyl-phenyl ether, ethyl-benzyl ether, furan, and the like; lower alkyl esters including, for example acetic acid isopropyl ester, acetic acid butyl ester, and propionic acid butyl ester, and the like; phthalic acid esters including, for example phthalic acid butyl ester, phthalic acid dioctyl ester and phthalic acid butyl-benxyl ester, and the like; oleic acid esters; adipic acid esters; azelaic acid esters; sebacic acid esters; stearic acid esters; benzoic acid esters; abietic acid esters; oxalic acid esters; phosphoric acid esters; and oils from higher alkyl acid esters such as castor oil.

The solvent for the isocyanate compound is desirably free of functional groups having active hydrogens such as, for example, carboxylic acids, hydroxy groups, thiols, or amino groups. Isocyanates may react with such functional groups, resulting in a decrease in water resistance. Where solvent is used with the isocyanate compound, it is desirable that the isocyanate compound is diluted by addition of solvent in an amount of 10 to 400 parts by weight, specifically 50 to 300 parts by weight, based on the weight of isocyanate compound.

Isocyanate compound is present in the EPI adhesive in an amount of about 1 to about 50 parts by weight (pbw), specifically about 2 to about 40 pbw, more specifically about 3 to about 30 pbw, and still more specifically about 5 to about 25 pbw, per 100 parts by weight of compounded emulsion polymer.

Aziridine compounds may also be used as a crosslinking agent, either in addition to or instead of the isocyanate compound, to crosslink the fast curing adhesive composition. Aziridine compounds having two or more pendant aziridine ring functional groups, and referred to herein as “polyfunctional aziridines” or “polyaziridines”, are useful as crosslinkers. Such compounds have a similar reactivity to the isocyanate compounds described herein. The aziridine compounds used to prepare the fast curing adhesive can comprise di-, tri-, tetra-, or polyvalent C₆-C₃₀ aryl, substituted C₆-C₃₀ aryl, C₁-C₃₀ alkyl, C₃-C₃₀ cycloalkyl, and substituted C₃-C₃₀ cycloalkyl groups, wherein substituents can include halogen, C₁-C₈ alkyl, and C₁-C₈ alkoxy groups. Specifically suitable polyaziridines include di- and tri-functional aziridine compounds. Higher molecular weight (e.g., greater than or equal to about 300) can desirably reduce the volatility of the aziridine-functional material.

Examples of useful aziridine compounds include dicyclohexylmethane-4,4′-diaziridine, diphenymethane-4,4′-diaziridine, 3-methoxy-1,6-hexamethylene diaziridine; 3-butoxy-1,6-hexamethylene diaziridine; omega, omega′-dipropylether diaziridine; 1,4-cyclohexyl diaziridine; 1,3-cyclohexyl diaziridine; trimethylhexamethylene diaziridine, tris-(2-methyl-1-aziridinyl)phosphine oxide), tris-(1-aziridinyl) phosphine sulfide, tris-(1-aziridinyl) phosphine oxide, trimethylolpropane tris-(2-methyl-1-aziridinepropionate), trimethylolpropane tris-(aziridinyl propionate), tetramethylolmethane tris(aziridinylpropionate), pentaerythritol tris-(3-(1-aziridinyl)propionate)), triethylenemelamine, triethylenethiophosphoramide, N,N′-toluene-2,4-bis(1-aziridinecarboxamide), N,N-hexamethylene-1,6-bis(1-aziridinecarboxamide), N,N′-hexamethylene-bis-1,6-bis-(2-methyl-1-aziridinecarboxamide), 1,6-hexanediol bis-(aziridinyl propionate), and 1,6-hexanediol bis-(2-methyl aziridinyl propionate). Specifically suitable are aziridine compounds which are adducts of trimethylol propane triacrylate or pentaerythritol triacrylate with aziridine or methyl aziridine, wherein tris-aziridine or tris-methylaziridine of trimethylol propane triacrylate, and the tris-aziridine or tris-methylaziridine of pentaerythritol triacrylate are formed. Examples of useful, commercially available polyaziridines include Crosslinker CX-100 from DSM Inc.; XAMA-7 from EIT, Inc.; and MAPO (tris-1-(2-methyl)aziridinyl phosphine oxide) from Aceto Corp. A useful water-based crosslinker is Polycup® 172 from Hercules. Aziridine compound, where used, may be present in the emulsion polymer adhesive in an amount of about 0 to about 10 parts by weight (pbw) of compounded emulsion polymer.

The solids content of the emulsion polymer adhesive, as it is used, may be about 20 to about 90 wt %, specifically about 30 to about 80 wt %, and more specifically about 40 to about 70 wt %. The emulsion polymer adhesives are water miscible and dilutable and can be cleaned with water before cure. As used herein, the solids content of a composition is measured by the weight loss upon heating of a small, e.g., about 1 to about 5 gram, sample of the composition at about 105° C. for about 3 hours. The emulsion polymer adhesive typically has a final Brookfield viscosity in the range of 500 to 10,000 centipoise (cP) at a solids content of 50 to 60% by weight.

As disclosed above, the emulsion polymer adhesive may be provided in two parts, with one component having the crosslinking compound, and the other having the compounded emulsion polymer and any other components that are reactive toward the crosslinking compound. Thickener is typically included in the component of the emulsion polymer adhesive that includes the compounded emulsion polymer (i.e., the compounded emulsion polymer component), and are typically not included with the crosslinking compound due to the reactivity of such compounds (e.g., isocyanate and aziridine compounds) toward hydroxyl groups. When combined, the compounded emulsion polymer component and crosslinking compound component can react with one another under ambient conditions, and thereby have a limited lifetime (i.e., pot life) of about 3 hours or less, under application conditions. An example of a suitable commercially available EPI adhesive is Wonderbond® EPI adhesive, from Hexion Specialty Chemicals, Inc. Typically, the two components of the EPI adhesive are combined immediately prior to use using either a batch mixing or continuous static mixing device.

The emulsion polymer adhesive has sufficient tack to provide an initial bond between lignocellulosic substrates (such as wood veneers, wood composites, and the like), or between lignocellulosic substrates and other non-lignocellulosic materials such as plastic, kraft paper laminates, or other substrates. An emulsion polymer adhesive also has a sufficiently high viscosity suitable to provide sag resistance for a stable location of the emulsion polymer adhesive on the surfaces of the lignocellulosic materials. Desirably, fast curing adhesives, including emulsion polymer adhesives such as EPI adhesives, do not include formaldehyde, and thus are free of formaldehyde-based components which may generate formaldehyde under manufacturing conditions. Thus, fast curing adhesives have zero formaldehyde emissions.

In general, multilayer articles are prepared which comprise the above-described EPI adhesive, a surface layer, and a substrate layer. Suitable surface layers may be of wood including for example wood veneer; plastic sheeting such as, for example, vinyl sheet; metal; decorative laminates such as kraft-paper laminate having a phenolic or melamine formaldehyde resin binder; or other suitable material. In an embodiment, the surface layer comprises a first lignocellulosic layer, and the substrate layer comprises a second lignocellulosic layer. The first lignocellulosic layer may be a wood veneer with a desirable, high quality visual appearance. The substrate layer may comprise at least one core layer comprising a lignocellulosic material. In an embodiment, the core layer is a second lignocellulosic layer. Suitable lignocellulosic materials for the core layer may include, for example, solid wood materials such as non-finish quality wood layers and veneers, as well as wood composite material including oriented strand board, particle board, plywood, medium density fiberboard, and the like. Wood composite materials are suitable for use as core layer materials where appearance of the core layer is not necessary. An additional layer, such as for example, an additional core layer and/or a backing veneer, may also be present in the multilayer article.

Wood composites may generally comprise an adhesive binder and lignocellulosic component. Suitable adhesive binders used to prepare lignocellulosic composite materials for use as a core layer may be prepared as follows. A solution of a suitable resin for forming the adhesive binder, such as a urea-formaldehyde resin, phenol-formaldehyde resin, melamine-urea-formaldehyde resin, or other non-formaldehyde-based adhesives (e.g. pMDI for OSB), and the like, or a combination comprising at least one of these, may be combined and blended. The adhesive binder may further contain additives such a formaldehyde scavengers, plasticizers, thickeners, fillers, flame retardants, lubricants, softening agents, pigments, biocides, wax, acidic cure catalysts, or a combination comprising at least one of these.

The adhesive binder may be used in an amount of about 1 to about 45 percent by weight based on the dry weight of the lignocellulosic components used in the core layer. Suitable lignocellulosic components may include materials such as sugar cane bagasse, straw, cornstalks, and other waste vegetable matter. In particular however, they are derived form various species of wood in the form of wood fibers, chips, shavings, flakes, particles, veneers, and flours. Examples of specific woods for use in preparing wood composites include soft and hard woods such as Douglas Fir, White Fir, Hemlock, Larch, Southern Yellow Pine, Ponderosa Pine, Yellow Poplar, and the like, and combinations comprising at least one of these. Processed lignocellulosic materials that are also useful include paper and other processed fibers. As is conventional in the art, the resin is combined with or applied to such lignocellulosic substrate materials by various spraying techniques.

In the making of plywood, the adhesive usage is generally expressed as “glue spreads”. Glue spreads of about 40 lbs to about 140 lbs of adhesive per 1,000 square feet (about 19.5 to about 68.3 Kg per 100 square meters) of glue line are used when a glue is applied to both sides of a veneer, and glue spreads of about 20 lbs to about 60 lbs per 1,000 sq. ft. (about 9.8 to about 34.1 Kg per 100 square meters) are used when the glue is spread on only one side of the veneer. When making plywood (such as hardwood plywood for interior applications), the adhesive can be applied to the veneers by roll coater, curtain coater, spray booth, foam extruder and the like.

Wood composites useful as core materials, such as oriented stand board, particleboard, flake board, medium density fiberboard, waferboard, and the like are generally produced by applying the adhesive binder to the lignocellulose materials (wood pieces), such as by blending or spraying the wood flakes, wood fibers, wood particles, wood wafers, wood strips, wood strands, or other comminuted lignocellulose materials with an adhesive binder composition while the materials are tumbled or agitated in a blender or equivalent apparatus. The coated wood pieces are formed into a loose mat, which then is generally compressed between heated platens or plates to cure the binder and bond the flakes, strands, strips, pieces, and the like, together in densified form. Conventional pressing processes, typically used to form wood composites useful as core materials, are generally carried out at temperatures of about 110° C. to about 275° C. in the presence of steam generated by liberation of entrained moisture from the wood or lignocellulosic materials.

Various forms of electromagnetic radiation such as radio frequency (RF), microwave, infrared (IR), ultraviolet (UV), electron beam (EB), etc. are often used to cure adhesives and coatings. For example, RF may be used to cure adhesives (including fast curing adhesives, urea-formaldehyde resins, phenol-formaldehyde resins, and the like) in the manufacture of wood composites, plywoods, and the like. In this method, radio frequency waves of 2 to 30 megacycles (also referred to as mega-Hertz and abbreviated MHz) are generated in a field between electrodes and transmitted through the panel. A typical RF source may produce 15 kilowatts of energy or more, depending upon the type of equipment used. The passage of radio waves through the wood generates a uniform heat in the curing wood mass, so that the center is heated about as fast and to the same extent as the outer surfaces. In contrast, hot pressing uses heated platens contacting the surfaces of the panels, and transfers heat slowly from the surfaces to the center, with the rate of heat transfer dependent upon the thermal insulating properties of the panel being hot pressed.

The RF field may be applied perpendicular to, parallel to, or randomly with respect to the glue line in the panels. In an exemplary embodiment, plywood panels may be cured by application of a perpendicular RF field to the panel. A “catalyst” for improving conductivity may be used (in amounts of up to 2 pbw per 100 pbw of adhesive) to improve and optimize cure performance of an RF field. An example of a suitable catalyst is sodium chloride. Moisture content may also affect the cure of the adhesive in the panel during irradiation, and is typically maintained at about 5 to about 9 weight percent of the mass of the panel.

The amount of RF energy applied to the panel to effect cure may be determined using known methods, and depends upon factors including the weight of the panel(s), moisture content, starting temperature, cure temperature, amount of adhesive present, and catalyst loading. Irradiation to transmit a suitable dose of RF radiation may be of a duration of 0.1 to 20 minutes or more. Some processes may use a combination of press curing with hot platens and cure with radio frequency irradiation. This combination may permit rapid curing with a reduced press time. The adhesive binder sets or cures at elevated temperatures below the decomposition temperature of the formaldehyde-containing resin mixture. Elevated cure temperatures greater than about 275° C. are not desirable as excessively high temperatures can cause deterioration of the adhesive binder composition, which can in turn cause deterioration of the physical and functional properties of the wood composite and lead to increased formaldehyde emissions. Lower temperatures and/or longer times for curing can also be employed to circumvent such undesirable outcomes. Wood composite products made using small wood pieces can also be made using an extrusion process. In such a process, for example, a mixture of the wood particles, adhesive binder, and other additives is extruded through a die to form a flat board.

A typical production cycle for a substrate layer (e.g., a core layer) material such as plywood comprises placing a back layer (wood ply or veneer) on a moving or stationary work surface. A center or core layer (ply) is run through a glue spreader that applies glue to both sides, and placed on the backing layer. Subsequent center or core plies are placed on top of a previous center or core ply. The grain of the wood in each internal ply runs transverse to the internal plies immediately adjacent to it. This process, referred to in the art as “laying up”, continues until a panel comprised of a number of layers is formed. The surface layer (wood ply or veneer) is placed on top of the uppermost internal ply and becomes the top of the panel. The assembling of these plies to form a panel is typically done by hand, but may also be performed using an automated assembly-line process. This panel is typically pressed in a cold prepress followed by pressing in a hot press at a temperature of about 110° C. to about 275° C. The time in the hot press can be about 0.1 to about 30 minutes, and is typically less than 20 minutes, and a lamination pressure of about 50 to about 1,000 psi (about 0.34 to about 6.89 mega-Pascals, MPa) is used. The panel may also be cured using RF irradiation as described above. Under these conditions, the panel is generally cured to the desired extent, and is subsequently removed from the press.

The substrate layer can vary greatly in thickness, depending on the desired multilayer article and type of material used to form the core layer(s). In an embodiment, the core layer may have a thickness of about 0.1 to about 2 inches (about 2.54 to about 50.8 millimeters), specifically about 0.15 to about 1.5 inches (about 3.81 to about 38.1 mm), more specifically about 0.2 to about 1 inches (about 5.08 to about 25.4 mm), and still more specifically about 0.25 to about 0.875 inches (about 6.35 to about 22.2 mm).

As disclosed herein, a process for forming multilayer articles comprises adhering the surface and substrate layers described hereinabove together using a fast setting adhesive (such as EPI adhesive), by cold pressing a stack of multilayer assemblies at ambient temperature, and thereby effecting bonding between the layers. In this process, the fast setting adhesive is typically applied to the substrate layer (e.g. a sheet of wood, plywood, or wood composite such as particle board, veneer core, OSB, MDF, and the like) by roll coater, curtain coater, spray booth, foam extruder and the like. A surface layer, such as for example a wood veneer or vinyl sheet, is applied. In an embodiment, the substrate layer comprises additional adhesive-coated layers applied to a core layer prior to application of the surface layer. In another embodiment, a backing layer is also applied to a side of the substrate layer opposite the surface layer. Multiple multilayer assemblies can be successively assembled (also referred to in the art as “lay up”) in this way. After assembly (i.e. adhesive application and lay up), the multilayer assemblies (panels) having alternating wood and/or or wood composite, and adhesive layers are stacked in the press, and are pressed in a cold press at ambient temperature by applying a uniform pressure to the stacked uncured articles, in a direction orthogonal to the plane of the articles in the stack, for a time sufficient to effect a bond between the layers of the multilayer article. Panels of the multilayer assemblies may thus be assembled from the surface layer, core layer, and backing layer, and pressed in a cold press to form the multilayer articles without need of hot pressing. The multilayer articles, upon removal from the press, have suitable initial bond strength and moisture resistance, and generally achieve a full cure upon storage at ambient temperature. Further processing to effect a full cure is unnecessary.

In the process, a fast setting adhesive may be prepared prior to coating on the substrate (core) layer(s). In an exemplary embodiment, EPI adhesive, as disclosed herein, is typically a two-part adhesive comprising a compounded emulsion polymer-containing component, and an isocyanate compound-containing component. The two components may be combined in a batch process and mixed using a suitable mixing process, such as hand mixing, or desirably using an efficient mixer. Alternatively, the components of the EPI adhesive may be combined using a continuous metering process wherein the components are fed into a mixing chamber continuously, thoroughly mixed, and applied directly to the core layer. Once combined, the EPI adhesive has a usable pot life of about 20 to about 180 minutes. After this time, the EPI adhesive can typically build to a viscosity that can adversely affect the coating properties such as uniformity of glue spread, and may develop gels or other partially cured particulate contaminants that can lead to appearance and uniformity defects in the multilayer article, or other undesirable gluing performance such as delamination.

The core layer is coated with the fast setting adhesive. Typical methods of performing the coating include spray coating of the adhesive in a spray booth; extrusion coating, such as using a foam of the adhesive extruded onto the core layer panel; curtain coating, wherein the adhesive is applied in a layer to a core layer panel as it passes beneath the applicator; or by roller coating wherein the adhesive is applied to a roller and transferred to the core layer panel by contacting the roller with adhesive to the core layer panel as the core layer panel is passed through the rollers. The roller coating method may be a one-side coating method, wherein adhesive is applied to a single side of the core layer; or a two-sided coating method, wherein adhesive is applied to both sides of the core layer. In one embodiment, roller application can be used to transfer adhesive to one side of the core layer panel. In another embodiment, roller coating can be used to transfer adhesive to both sides of the core layer panel. In a specifically useful embodiment, the core layer is coated on both sides with fast setting adhesive, using the two-sided roller coating method.

Adhesive usage is expressed as glue spread. For the layers of the multilayer article, glue spreads of about 20 to about 70 lbs of fast setting adhesive per about 1,000 square feet (about 9.8 to about 34.2 Kg per 100 square meters) of contacting area of the lignocellulosic layers may be used, per coated side of the layer. In an embodiment, a glue spread of about 30 lbs to about 60 lbs per 1,000 sq. ft. (about 14.7 to about 29.4 Kg per 100 square meters) of contacting area of the lignocellulosic layers may be used, per coated side of the layer. After application, the aqueous portion of the fast setting adhesive may optionally be removed from the surface, in a drying step. Where a drying step is desired, the solvent may be removed using heat, air flow, vacuum, or a combination comprising at least one of these methods. In an embodiment, the coated lignocellulosic layer is contacted to a second layer without drying prior to cold pressing.

The multilayer articles are assembled (i.e., are laid up) by contacting a side of the substrate layer coated with fast setting adhesive with a surface layer, typically a wood veneer. The contacting sides of the substrate layer and surface layer thus have fast curing adhesive disposed there between. Wood veneer, where used, is typically of a high visual quality having is substantially free of defects, i.e., has a low observable incidence of defects such as knots, blemishes, burns, splits, and the like. Where the surface layer is a wood veneer, the wood used for the veneer can be a hardwood with a desirable grain, hardness, and appearance, such as, for example, birch, oak, maple, teak, mahogany, cherry, walnut, hickory, and the like. In another embodiment, a non-lignocellulosic layer (e.g., vinyl sheet) may also be used.

The multilayer article can further have a backing layer such as, for example, a wood veneer, plastic sheet, metal, or kraft-paper laminate. Typically, the backing layer is a wood veneer of a lower grade than that of the surface layer, contacted to a side of the substrate layer also coated with fast setting adhesive and opposite the side of the substrate layer opposite the surface layer. The contacting sides of the substrate layer and backing layer thus have fast curing adhesive disposed there between. The backing layer is typically not selected for high quality visual appearance, and is not typically the side of the finished multilayer article that is displayed in an end-use article prepared from the multilayer article. Typically therefore, where the backing layer is a wood veneer, a lower grade hardwood veneer having higher defectivity than the surface layer is used. Hardwoods typically used for the backing layer include lower grades with higher defectivity of lower cost hardwoods such as, for example, maple, oak, poplar, and the like.

In an embodiment, the substrate layer may comprise at least two core layers, each of which has a first side and a second side opposite the first side. The core layers are coated with fast setting adhesive so that the fast setting adhesive is disposed on each of the first side and second sides of each core layers, and the coated sides of the core layers are contacted to form the substrate layer. In a specific embodiment, the core layers are wood plies suitable for forming plywood. A surface layer is then contacted to the first side of the substrate layer, and a backing layer is contacted to the second side of the substrate layer. In a specific embodiment, the multilayer assembly is a hardwood plywood panel assembly.

Typically, wood veneers used in the surface layer and backing layer are significantly thinner than the core layer. In an embodiment, the surface layer has a thickness of about 0.01 to about 0.4 inches (about 0.25 to about 10 millimeters), specifically about 0.015 to about 0.1 inches (about 0.38 to about 2.54 mm), more specifically about 0.0175 to about 0.05 inches (about 0.44 to about 1.27 mm), and still more specifically about 0.02 to about 0.025 inches (about 0.51 to about 0.64 mm). In an embodiment, the backing layer has a thickness of about 0.01 to about 0.4 inches (about 0.25 to about 10 millimeters), specifically about 0.015 to about 0.1 inches (about 0.38 to about 2.54 mm), more specifically about 0.0175 to about 0.05 inches (about 0.44 to about 1.27 mm), and still more specifically about 0.02 to about 0.025 inches (about 0.51 to about 0.64 mm).

In an advantageous feature, the multilayer assemblies (panels) so assembled are stacked in a cold press (i.e., a non-heated panel press), also referred in the art as a “pre-press”, and pressed so that multiple panels are pressed simultaneously. The number of panels in the press may be determined by the capacity of the press to accommodate a number of panels of a given thickness. At least two panels may be pressed simultaneously. Typically, for example, for panels having a thickness of about 0.25 inches (about 0.64 cm), batch sizes of up to about 50 panels of the before-cure multilayer article may be laid up and pressed simultaneously in a single press. Where the panels are thinner, a batch size of more than about 50 panels may be pressed simultaneously. Where the panels are thicker i.e., about 0.75 inches (1.9 cm) for example, batch sizes of up to about 25 panels may be pressed simultaneously. The panels are pressed under uniform pressure of about 50 to about 300 psi (about 0.34 to about 2.07 MPa) for a period of less than 20 minutes per batch, at ambient temperature. As used herein, the term “uniform pressure” means pressure applied evenly to all points of the surface of the panel or stack of panels being pressed, and which varies by less than 5% between any two random points on the surface. The panels, after subsequent removal from the press, may be stored at ambient temperature and allowed to age. Aging of the panels allows the fast setting adhesive to build bond strength between the layers. A suitable time period for aging of the panels may be from about 1 hour to about 30 days, depending on process variables including, but not limited to, the ambient temperature, humidity, type of layers used, fast setting adhesive composition, and amount of fast setting adhesive. Typically, a suitable aging period may be greater than about 1 day, specifically from about 1 day to about 3 days.

Surprisingly, it has been found that the process described herein is useful for forming a bond between layers of the multilayer article when pressed at ambient temperatures of about 45° F. to about 120° F. (about 7° C. to about 49° C.) in a cold press at typical cold press lamination pressures, for short press times of less than 30 minutes, and with no subsequent hot pressing. While not wishing to be bound by theory, it is believed that, where a fast setting adhesive based on an emulsion polymer is used, the emulsion particles dispersed on the contacting surface form a continuous phase upon application of pressure, and thereby form an adhesive bond between the layers. The multilayer article is thus sufficiently pressure bonded after applying pressure by cold pressing. After cold pressing, it is further believed that, where a low temperature curing is desired, the crosslinking compound of the fast curing adhesive continues to react (i.e., cure) by forming crosslinks between the compounded emulsion polymer and the crosslinking compound, between molecules of the crosslinking compound, and possibly between the lignocellulosic substrate and the crosslinking compound, and that a full cure is eventually obtained at a time of up to a week after cold pressing the multilayer article. After full cure, the multilayer article reaches its maximum moisture resistance and thereby maximum resistance to delamination. The panels may also be cured by irradiation using radio-frequency (RF) radiation, wherein the panels are irradiated before cold pressing, during cold pressing, after cold pressing, or a combination comprising at least two of these. Curing using a combination of RF cure and cure at ambient temperature may also be used to achieve the desired level of cure and in a desirable period of time, for the multilayer article.

In an embodiment, a suitable lamination pressure is about 50 to about 300 pounds per square inch (about 0.34 to about 2.04 MPa), specifically about 60 to about 250 psi (about 0.41 to about 1.70 MPa), more specifically about 70 to about 230 psi (about 0.48 to about 1.56 MPa), and still more specifically about 80 to about 200 psi (about 0.55 to about 1.36 MPa). In an embodiment, the multilayer article is pressed for a time of 0.1 to 20 minutes, specifically 1 to 15 minutes, more specifically 2 to 10 minutes, and still more specifically 3 to 8 minutes. Multilayer articles (e.g., wood laminates) prepared using the fast setting adhesive may have suitably low formaldehyde emissions, with zero emissions attributable to the fast curing adhesive, such that the multilayer articles prepared by this method are in accord with LEED standards. The multilayer articles may be tested for emissions of formaldehyde under a dynamic flow of air within a chamber in accordance with the “large chamber test” for determining formaldehyde emissions in accordance with the test procedure set forth in ASTM E1333.

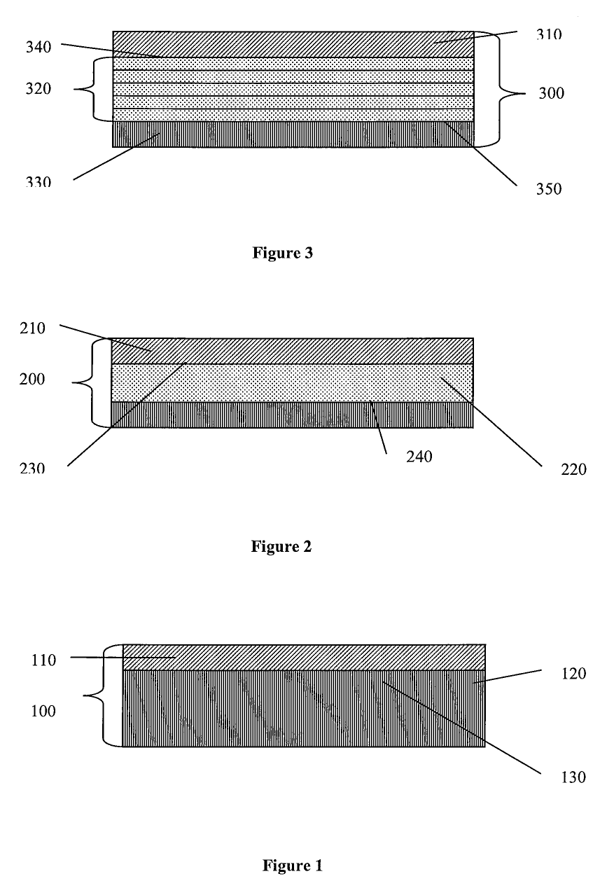

The above described fast setting adhesive and lignocellulosic layers are used to form multilayer articles, such as wood laminates. An exemplary embodiment of a two-ply multilayer article 100 is shown in FIG. 1. FIG. 1 depicts a multilayer article 100 having a surface layer 110, and a core layer 120 comprising the fast setting adhesive 130 disposed there between. As used herein “disposed” means in at least partial contact with. In a specific embodiment, core layer 120 is a veneer backing. In another specific embodiment, the surface layer is a wood veneer or vinyl sheet.

In other embodiment, the multilayer article is a three-ply article, for example as shown in FIG. 2 at 201. FIG. 2 depicts a multilayer article 200 having a surface layer 210, a core layer 220, and a backing layer 240. Fast setting adhesive 230 is disposed between the surface layer 210 and core layer 220. Fast setting adhesive 230 is also disposed between core layer 220 and backing layer 240. In a specific embodiment, the three-ply multilayer article is a decorative hardwood plywood with surface, core and backing or 3-ply hardwood flooring panel. In another embodiment, a non-lignocellulosic surface layer may also be used.

The multilayer article may further comprise an additional layer, wherein the additional layer is disposed between the core layer 220 and backing layer 240. Where the additional layer is included, a fast setting adhesive may be disposed between the core layer 220 and additional layer (not shown). Where the additional layer is present, fast setting adhesive may be disposed between the additional layer and the backing layer 230. In a specific embodiment, the additional layer may be a veneer backing or wood composite. In another specific embodiment, the adhesive disposed between the core layer 220 and additional layer, and between the additional layer and backing layer 240, is EPI adhesive.

In other embodiment, the multilayer article comprises more than three layers, for example as shown in FIG. 3. FIG. 3 depicts a multilayer article 300 comprising a surface layer 310, a substrate layer 320, wherein the substrate layer comprises multiple core layers, and a backing layer 330. Fast setting adhesive 340 is disposed between the surface layer 310 and substrate layer 320. Fast setting adhesive 350 is also disposed between the substrate layer 320 and backing layer 330. In a specific embodiment, the substrate layer 320 is a plywood. In a more specific embodiment, the multilayer article 300 is a decorative hardwood plywood. In an embodiment, the substrate layer 320 comprises multiple alternating core layers with fast setting adhesive disposed there between. In a specific embodiment, the core layers are wood veneers or sheets. It will be understood that substrate layer 320, herein depicted as comprising five core layers in FIG. 3, is for the purpose of illustration only, and the number of layers shown is not to be considered as limiting of the scope of the invention disclosed herein. Substrate layer 320 may thus comprise up to 30 such core layers, as determined by the practitioner according to the layer requirements for the desired article. In another specific embodiment, the fast setting adhesive is EPI adhesive.

Thus, in one embodiment, the multilayer article comprises a surface layer disposed on the core layer. In a further embodiment, an additional layer is disposed between the surface layer and the core layer. In another further embodiment, further additional layer may be disposed between the surface layer and the core layer. In an embodiment, the surface layer, the layers of the core layer, and the backing layer are each adhered to the adjacent layer using fast setting adhesive. In another specific embodiment, the surface layer is a non-lignocellulosic layer (e.g., a vinyl sheet).

The multilayer article prepared by the method thus comprises a surface layer, core layer, and may further comprise a backing layer, with a cure product of fast setting adhesive disposed there between. In an embodiment, the multilayer article has a thickness of about 0.15 to about 2.05 inches (about 3.81 to about 52.1 millimeters), specifically about 0.17 to about 1.55 inches (about 4.3 to about 39.4 mm), more specifically about 0.22 to about 1.05 inches (about 5.6 to about 26.7 mm), and still more specifically about 0.27 to about 0.88 inches (about 6.9 to about 22.4 mm).

It is contemplated herein that the combinations of type and number of layers in the multilayer articles disclosed herein can be present in any one of a number of combinations wherein, for example, the article is a multi-ply article having n plies, wherein n is an integer from 2 to 32. It will further be appreciated by one skilled in the art that the multilayer article disclosed herein may be used with a variety of combinations of lignocellulosic and non-lignocellulosic (e.g. vinyl) layers suitable to provide different and useful multilayer articles and combinations within the scope of this disclosure, and that the multilayer articles disclosed herein are not limited to the particular combination and/or numbers of additives and layers, and compositions thereof disclosed in the foregoing exemplary embodiments. The multilayer articles disclosed herein should therefore not be considered as limited thereto.

In a specific embodiment, 3-ply panels may be prepared by coating a core layer material with fast setting adhesive on both sides using a roller coater, and assembling the panel by layering a backing layer, core layer, and surface layer of wood veneer into panels of about 4 feet by about 8 feet (about 120 cm by about 240 centimeters). The panels are laid up and stacked in a cold press and pressed at a pressure of about 80 to about 150 psi (about 0.55 to about 1.03 MPa) for a period of about 3 to about 8 minutes, and at ambient temperature. In a more specific embodiment, the multilayer article so prepared is a flooring panel. In another more specific embodiment, where the core layer is a multilayer plywood, the multilayer article is a decorative hardwood plywood. In another embodiment, the decorative hardwood plywood has 3, 5, 7, or more plies. In a further embodiment, the stacked panels may be cured using radio frequency (RF) cure. In an embodiment, a stack of panels may be irradiated using RF radiation during pressing as described hereinabove. In another embodiment, a stack of panels may be irradiated using RF radiation after cold pressing.

As disclosed herein, the above process is suitable for preparing hardwood floor panels, decorative hardwood plywoods, decorative particleboard, decorative medium density fiberboard, and the like, where the decorative veneer (cellulosic or non-cellulosic) may be on one or both sides of the multilayer article.

In at least on embodiment, the process of the application is performed using an adhesive that is free of solvent. For example, the adhesive may have less than 5 percent of an organic solvent. In some embodiments the adhesive may have less than 1 percent by weight of an organic solvent. In still another embodiment, the adhesive may be substantially free of organic solvents.

The process of the invention may be, in some embodiments, practiced using an adhesive including a compounded emulsion polymer and a crosslinking compound, and no other materials that would materially affect the adhesive. For example, in some embodiments, the adhesive would have less than 5 weight percent of other components. In other embodiments, the adhesive would have less than 1 weight percent of other components. In still other embodiments, the adhesive would have less than 0.1 weight percent of other components.

The process of the invention may be, in some embodiments, practiced with adhesives that are prepared using an compounded emulsion polymer that optionally includes a thickener and a filler and no other materials that would materially affect the properties of the compounded emulsion polymer. For example, in some embodiments, the compounded emulsion polymer would have less than 5% by weight of other materials. In other embodiments, the compounded emulsion polymer would have less than 1% by weight of other materials. In still other embodiments, the compounded emulsion polymer would have less than 0.1% by weight of other materials

The following examples are intended to be illustrative only and are not intended to be limiting thereto.

The “3-cycle soak” test, ANSI/HPVA HP-1-1994, which is incorporated herein in its entirety by reference, is a standard plywood industry test wherein 127 mm by 50.8 mm (5 inches by 2 inches) specimens from each test panel of plywood are submerged in water at 24 plus or minus 3° C. for 4 hours, then dried at a temperature of about 49 to about 52° C. for 19 hours with sufficient air circulation to lower the moisture content of the specimens to within the range of 4 to 12 percent of the overall dry weight of the panel The cycle is repeated until all specimens fail or until three cycles have been completed, whichever occurs first. A specimen is considered to fail when any single delamination between two plies is greater than 50.8 mm in continuous length, over 6.4 mm in depth at any point, and 0.08 mm in width, as determined by a feeler gage 0.08 mm thick and 12.7 mm wide. Delaminations due to tape at joints of inner plies or defects allowed by the grade are disregarded. Five of the six specimens must pass the first cycle and four of six specimens must pass the third cycle in 90% of the panels tested.

Within any given selection of test panels, 95% of the individual specimens must pass the first cycle and 85% of the specimens must pass the third cycle to achieve a “passed” rating.

Panels were prepared using the following materials (Table 1).

TABLE 1

| Acronym | Description | Supplier |
|---|---|---|
| Adhesive: | | |
| EPI | WS799-56G-1 (Compounded emulsion latex | Hexion Specialty |
| Component 1 | with 20-25% by weight CaCO₃ filler) | Chemicals |
| EPI | Wonderbond ® EPI CL-1 isocyanate | Hexion Specialty |
| Component 2 | crosslinker | Chemicals |
| Veneers: | — | — |
| Oak | Oak veneer, 0.02-0.025″ (0.5-0.64 mm) | — |
| | (surface layer) | |
| Maple | Maple veneer, 0.02-0.025″ (0.5-0.64 mm) | — |
| | (backing layer) | |
| Core Layers:¹ | — | — |
| ¾ VC | Veneer core, 0.75″ (1.9 cm) thickness | — |
| | (poplar) | |
| ¼ VC | Veneer core, 0.25″ (0.64 cm) thickness | — |
| 16 mm VC | Veneer core, 16 mm thickness | — |
| PB | Particle board core, 0.75″ (1.9 cm) thickness | — |
| MDF | Medium Density Fiberboard, 0.75″ (1.9 cm) | — |
| | thickness | |
| ¾ PC | Plywood core, 0.75″ (1.9 cm) thickness | — |
| ⅝ PC | Plywood core, 0.625″ (1.6 cm) thickness | — |
| 3.8 mm PC | Plywood core, 0.15″ (3.8 mm) thickness | — |
| PLFC | Platform core, 0.75″ (1.9 cm) thickness | — |
| 3-ply Flex | 3 ply flexible plywood core, ⅛″ (0.32 cm) | — |
| | thickness | |
| 5 ply Flex | 5 ply flexible plywood core, ⅛″ (0.32 cm) | — |
| | thickness | |

¹All surface, core and backing layer materials measure 4 feet by 8 feet (120 cm by 240 cm).

Panels for testing were assembled as follows. EPI adhesive was prepared by combining 100 parts by weight of EPI component 1 with 10 parts by weight of EPI Component 2, in batches of about 40 pounds (18.1 Kg). A 2-roll wood panel roll coater dispensing pre-mixed EPI adhesive was used to coat the EPI adhesive onto both sides of a core layer material (Table 1, above). The EPI adhesive was applied in an amount of about 20-35 lb/1,000 sq. ft. (about 9.8 Kg/100 m²; about 17.2 Kg/100 m²). The panels were assembled by successive layering of a backing ply of maple veneer, a core layer coated with EPI adhesive, and a surface ply of oak veneer. A total of 3 to 15 replicate panels of each layer combination was prepared. The panels were laid up and stacked in a cold press (i.e., a non-heated panel press), and pressed in batch mode of stacks of 6 to 21 panels, at 100-105 psi (0.69-0.72 MPa) for a period of 4-9 minutes per batch, at ambient temperature of about 75° F. (about 24° C.).

The panels were subsequently removed from the press, and aged (1-3 days) at ambient temperature to achieve sufficient cure for testing. Selected panels were subsequently tested for delamination using the above described 3-cycle soak test according to HP-1-1994.

### Examples 1-3

Three core layer/veneer combinations having oak veneer (surface ply), maple veneer (backing ply), and either PB core, PLFC core, or MDF core layers, and using EPI adhesive, were assembled using a press pressure of 105 psi (0.74 MPa) and a press time of 7 minutes. Seven replicates of each combination were made, and were laid up, stacked, and pressed in a single batch. The details of Examples 1-3 are shown in Table 2, below. Note: In Table 2, the panel number in the press load shows the ordering of the panels in the press from the top panel (no. 1) to the bottom panel (highest no.).

TABLE 2

| | Ex. 1 | Ex. 2 | Ex. 3 |
|---|---|---|---|
| Core layer | PB | PLFC | MDF |
| No. of replicate panels | 7 | 7 | 7 |
| Panel Nos. (in press load) | 1-7 | 8-14 | 15-21 |
| Press time (min) | 7 | 7 | 7 |
| Closed assembly time (min) | 6 | 6 | 8-9 |
| Test panel for soak test | Panel 7 | Panel 8 | Panel 20 |
| 3-cycle soak test² (Pass/Fail) | Pass | Pass | Pass |

²ANSI/HPVA HP-1-1994.

Specimens from each of the test panels, measuring 5 inches by 2 inches (12.7 cm by 5 cm), were cut from the panel and measured by the 3-cycle soak test as described above. Each of the panels passed the 3-cycle soak test (ANSI/HPVA HP-1-1994).

### Examples 4-12

Nine core layer/veneer combinations having oak veneer (surface ply), maple veneer (backing ply), and either PB core, PLFC core, or MDF core layers, and using EPI adhesive, were assembled using a press pressure of 100 psi (0.64 MPa) and a press time of 5-6 minutes. Seven replicates of each combination were made, and were laid up, stacked, and pressed in a single batch. The details of Examples 1-3 are shown in Table 2, below. Note: In Table 3, the panel number in the press load shows the ordering of the panels in the press from the top panel (no. 1) to the bottom panel (highest no.).

TABLE 3

| | Ex. 4 | Ex. 5 | Ex. 6 | Ex. 7 | Ex. 8 | Ex. 9 | Ex. 10 | Ex. 11 | Ex. 12 |
|---|---|---|---|---|---|---|---|---|---|
| Core layer | ¾ VC | MDF | ¾ PC | ⅝ PC | 16 mm PC | 3.8 mm PC | ¼ VC | 3 ply Flex | 5 ply Flex |
| No. of replicate | 15 | 15 | 3 | 10 | 6 | 10 | 10 | 5 | 5 |
| panels | | | | | | | | | |
| Press load | 1 | 2 | 3 | 3 | 4 | 5 | 6 | 7 | 7 |
| Panel Nos. (in | 1-15 | 8-14 | 1-3 | 4-13 | 1-6 | 1-10 | 1-10 | 1-5 | 5-10 |
| press load) | | | | | | | | | |
| Press time (min) | 6 | 6 | 5 | 5 | 5 | 5 | 5 | 6 | 6 |
| Test panel for | — | — | — | — | — | — | — | — | 6, 8, 10 |
| soak test | | | | | | | | | |
| 3-cycle soak | — | — | — | — | — | — | — | — | Pass (all) |
| test (Pass/Fail) | | | | | | | | | |

Six samples of each of the test panels from Example 12, each measuring 5 inches by 2 inches (12.7 cm by 5 cm), was cut from the panel and measured by the 3-cycle soak test as described above. Each of the panels passed the 3-cycle soak test (ANSI/HPVA HP-1-1994).

The singular forms “a,” “an,” and “the” include plural referents unless the context clearly dictates otherwise. The endpoints of all ranges reciting the same characteristic or referring to the quantity of the same component are independently combinable and inclusive of the recited endpoint. All cited patents, patent applications, and other references are incorporated herein by reference in their entirety.

While typical embodiments have been set forth for the purpose of illustration, the foregoing descriptions should not be deemed to be a limitation on the scope herein. Accordingly, various modifications, adaptations, and alternatives may occur to one skilled in the art without departing from the spirit and scope herein.

We claim:

1. A process to form a multilayer article comprising pressing a stack comprising two or more panels;
wherein each panel comprises a surface layer and a substrate layer, wherein a side of the surface layer is contacted to a side of the substrate layer, and wherein the contacting sides of the surface layer and substrate layer have a fast-setting adhesive comprising (i) a compounded emulsion polymer selected from the group consisting of a styrene-butadiene rubber latex, a modified styrene-butadiene rubber latex, polyvinyl acetate, ethylene vinyl acetate, and combinations thereof and (ii) pMDI as a crosslinking compound disposed there between; and
wherein pressing comprises applying uniform pressure to the stack orthogonal to the plane of the panels, at ambient temperature and for a time of at least 0.1 minutes, and with no subsequent hot pressing.

2. The process of claim 1, wherein the panel further comprises a backing layer, wherein a side of the backing layer is contacted to a side of the substrate layer opposite the surface layer, and wherein the contacting sides of the substrate layer and backing layer have fast setting adhesive disposed there between.

3. The process of claim 2, wherein the article further comprises an additional layer disposed between the substrate layer and the backing layer, wherein a side of the additional layer is contacted to the side of the substrate layer opposite the surface layer, and a side of the additional layer opposite the substrate layer is contacted to a side of the backing layer, and wherein the contacting sides of the additional layer and substrate layer, and the contacting sides of the additional layer and the backing layer, each have fast setting adhesive disposed there between.

4. The process of claim 1, wherein the panels are irradiated using radiation cure.

5. The process of claim 1, wherein the compounded emulsion polymer comprises an emulsion polymer; a thickener in an amount of about 1 to about 10 parts by weight per 100 parts by weight of the compounded emulsion polymer; and a filler in an amount of about 5 to about 50 parts by weight per 100 parts by weight of compounded emulsion polymer.

6. The process of claim 7 wherein the pMDI is present in an amount of about 1 to about 50 parts by weight per 100 parts by weight of compounded emulsion polymer.

7. The process of claim 1, wherein the surface layer or backing layer is a wood veneer, plastic sheet, metal, or kraft-paper laminate.

8. The process of claim 1, wherein the substrate layer is a core layer comprising a wood veneer, oriented strand board, particle board, plywood, or medium density fiberboard.

9. The process of claim 3, wherein the additional layer is wood veneer, oriented strand board, particle board, plywood, or medium density fiberboard.

10. The process of claim 1, wherein the uniform pressure is about 50 to about 300 pounds per square inch (about 0.34 to about 2.04 MPa).

11. A multilayer article prepared by the process of claim 1.

12. A process to form a multilayer article comprising pressing a stack comprising two or more panels;
wherein each panel comprises a surface layer and a substrate layer, wherein a side of the surface layer is contacted to a side of the substrate layer, and wherein the contacting sides of the surface layer and substrate layer have a fast-setting adhesive comprising (i) a compounded ethylene vinyl acetate emulsion polymer and (ii) a crosslinking compound disposed there between; and
wherein pressing comprises applying uniform pressure to the stack orthogonal to the plane of the panels, at ambient temperature and for a time of at least 0.1 minutes, and with no subsequent hot pressing.

13. The process of claim 12, wherein the panel further comprises a backing layer, wherein a side of the backing layer is contacted to a side of the substrate layer opposite the surface layer, and wherein the contacting sides of the substrate layer and backing layer have fast setting adhesive disposed there between.

14. The process of claim 13, wherein the article further comprises an additional layer disposed between the substrate layer and the backing layer, wherein a side of the additional layer is contacted to the side of the substrate layer opposite the surface layer, and a side of the additional layer opposite the substrate layer is contacted to a side of the backing layer, and wherein the contacting sides of the additional layer and substrate layer, and the contacting sides of the additional layer and the backing layer, each have fast setting adhesive disposed there between.

15. The process of claim 12, wherein the panels are irradiated using radiation cure.

16. The process of claim 12, wherein the compounded emulsion polymer comprises an emulsion polymer; a thickener in an amount of about 1 to about 10 parts by weight per 100 parts by weight of the compounded emulsion polymer; and a filler in an amount of about 5 to about 50 parts by weight per 100 parts by weight of compounded emulsion polymer.

17. The process of claim 12, wherein the surface layer or backing layer is a wood veneer, plastic sheet, metal, or kraft-paper laminate.

18. The process of claim 12, wherein the substrate layer is a core layer comprising a wood veneer, oriented strand board, particle board, plywood, or medium density fiberboard.

19. The process of claim 12, wherein the additional layer is wood veneer, oriented strand board, particle board, plywood, or medium density fiberboard.

20. The process of claim 12, wherein the uniform pressure is about 50 to about 300 pounds per square inch (about 0.34 to about 2.04 MPa).

21. A multilayer article prepared by the process of claim 12.
